(19) United States
(12) Patent Application Publication
(10) Pub. No.: US 2015/0220102 A1
(43) Pub. Date: Aug. 6, 2015

(54) LEVEL DETECTION CIRCUITS AND SEMICONDUCTOR DEVICES INCLUDING THE SAME

(71) Applicant: SK hynix Inc., Icheon-si (KR)

(72) Inventor: Ig Soo KWON, San Ramon, CA (US)

(73) Assignee: SK hynix Inc., Icheon-si (KR)

(21) Appl. No.: 14/174,350

(22) Filed: Feb. 6, 2014

(51) Int. Cl. G05F 3/16

(52) U.S. Cl. CPC G05F 3/16

(57) ABSTRACT

Level detection circuit includes a reference voltage generator, a level signal generator, and a comparator. The reference voltage generator includes a temperature dependent element and generates a reference voltage signal whose level varies according to a temperature characteristic of the temperature dependent element. The level signal generator includes a temperature compensation element and generates a level signal from a target voltage signal. A level of the level signal varies according to a temperature characteristic of the temperature compensation element. The comparator compares a level of the level signal with a level of the reference voltage signal to generate a detection voltage signal.

### BACKGROUND

1. Technical Field

Embodiments of the present disclosure generally relate to level detection circuits and semiconductor devices including the same.

2. Related Art

Level detection circuits may discriminate whether a voltage level of a specific signal is higher than a level of a reference voltage signal or not and may output a detection signal that is determined according to the discrimination results. The level detection circuits may be widely utilized in initialization circuits or voltage generation circuits of semiconductor devices.

The initialization circuit may execute an initialization operation before a power supply reaches a predetermined level after the power supply is applied to a semiconductor device. In order to set a period that the initialization operation is executed, the initialization circuit may discriminate whether the power supply reaches a predetermined level using the level detection circuit. That is, the level detection circuit may control the initialization operation of the semiconductor device by generating an initialization signal whose level is changed when the power supply applied to the semiconductor device reaches a predetermined level.

Meanwhile, the voltage generation circuit may generate a core voltage supplied to a core region in which a memory cell array is formed, a peripheral voltage supplied to a peripheral circuit region in which a control circuit is formed, and an internal voltage such as a pumping voltage supplied to word lines. The voltage generation circuit may detect a level of the internal voltage generated therein to drive the internal voltage to an external voltage or to pump or boost the internal voltage to a level higher than the external voltage when the internal voltage is lower than a predetermined level. The voltage generation circuit may require the level detection circuit to detect a level of the internal voltage.

### SUMMARY

Various embodiments are directed to level detection circuits and semiconductor devices including the same.

According to some embodiments, a level detection circuit includes a reference voltage generator, a level signal generator, and a comparator. The reference voltage generator includes a temperature dependent element and generates a reference voltage signal whose level varies according to a temperature characteristic of the temperature dependent element. The level signal generator includes a temperature compensation element and generates a level signal from a target voltage signal. A level of the level signal varies according to a temperature characteristic of the temperature compensation element. The comparator compares a level of the level signal with a level of the reference voltage signal to generate a detection voltage signal.

According to further embodiments, a semiconductor device includes a level detection circuit and a control circuit. The level detection circuit compares a level of a level signal generated from a target voltage signal with a level of a reference voltage signal to generate a detection voltage signal. The control circuit generates a control signal for controlling an internal circuit in response to the detection voltage signal. A level of the reference voltage signal varies according to a temperature characteristic of a temperature dependent element. A level of the level signal varies according to a temperature characteristic of a temperature compensation element.

According to further embodiments, a semiconductor device includes a first level detection circuit suitable for comparing a level of a first level signal generated from a first target voltage signal with a level of a first reference voltage signal to generate a first detection voltage signal, a second level detection circuit suitable for comparing a level of a second level signal generated from a second target voltage signal with a level of a second reference voltage signal to generate a second detection voltage signal, and a control circuit suitable for generating a control signal for controlling an internal circuit in response to the first and second detection voltage signals. A level of the first reference voltage signal varies according to a temperature characteristic of a first temperature dependent element. A level of the first level signal varies according to a temperature characteristic of a first temperature compensation element.

According to further embodiments, a system includes: a memory controller suitable for receiving a request and a data from the processor; and a memory device suitable for receiving the request and the data from the controller, wherein the memory device includes a level detection circuit, the level detection circuit including: a reference voltage generator suitable for including a temperature dependent element and suitable for generating a reference voltage signal whose level varies according to a temperature characteristic of the temperature dependent element; a level signal generator suitable for including a temperature compensation element and suitable for generating a level signal from a target voltage signal, a level of the level signal varying according to a temperature characteristic of the temperature compensation element; and a comparator suitable for comparing a level of the level signal with a level of the reference voltage signal to generate a detection voltage signal.

### BRIEF DESCRIPTION OF THE DRAWINGS

Embodiments of the present invention will become more apparent in view of the attached drawings and accompanying detailed descriptions, in which:

FIG. 1 is a block diagram illustrating a level detection circuit according to an embodiment of the present invention;

FIG. 2 is a circuit diagram illustrating a reference voltage generator included in the level detection circuit of FIG. 1;

FIG. 3 is a circuit diagram illustrating a level signal generator included in the level detection circuit of FIG. 1;

FIG. 4 is a circuit diagram illustrating a comparator included in the level detection circuit of FIG. 1;

FIG. 5 is a graph illustrating an operation of the level detection circuit shown in FIG. 1 according to a temperature variation;

FIG. 6 is a bock diagram illustrating a semiconductor device including a level detection circuit according to an embodiment of the present invention; and

FIG. 7 is a bock diagram illustrating a semiconductor device including a level detection circuit according to an embodiment of the present invention.

FIG. 8 illustrates a block diagram of a system employing a level detection circuit in accordance with the embodiments of the present invention.

### DETAILED DESCRIPTION OF THE EMBODIMENTS

Various embodiments of the present invention will be described hereinafter with reference to the accompanying drawings. However, the embodiments described herein are for illustrative purposes only and are not intended to limit the scope of the present invention.

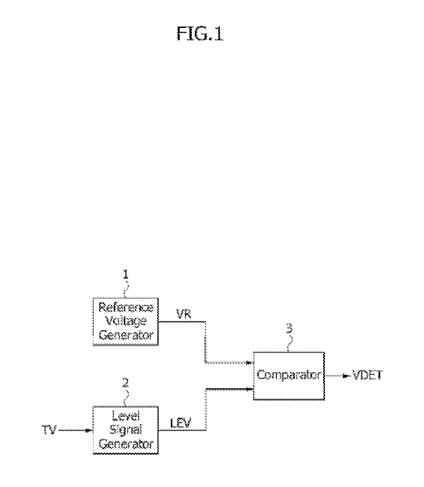

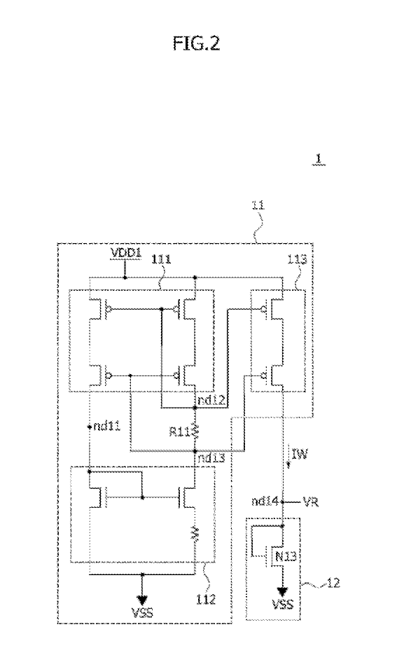

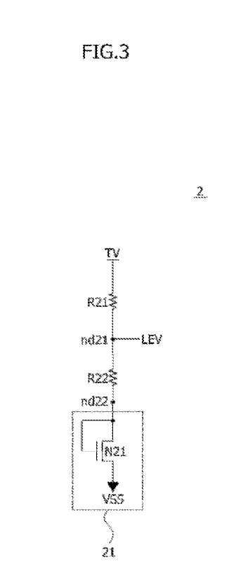

Referring to FIG. 1, a level detection circuit according to an embodiment of the present invention may include a reference voltage generator 1, a level signal generator 2, and a comparator 3. The reference voltage generator 1 may generate a reference voltage signal VR whose level varies according to a temperature characteristic of a temperature dependent element (see a component indicated by a reference numeral 12 of FIG. 2). The level signal generator 2 may generate a level signal LEV from a target voltage signal TV. A level of the level signal LEV may vary according to a temperature characteristic of a temperature compensation element (see a component indicated by a reference numeral 21 of FIG. 3). The comparator 3 may compare a level of the level signal LEV with a level of the reference voltage signal VR to generate a detection voltage signal VDET.

Referring to FIG. 2, the reference voltage generator 1 may include a constant current source 11 and a temperature dependent element 12. The constant current source 11 may include a current supplier 111, a resistor R11, a current discharger 112, and a driver 113. The current supplier 111 may supply a current from a first power voltage terminal VDD1 to a node nd11 and a node nd12. The resistor R11 may be coupled between the node nd12 and a node nd13. The current discharger 112 may discharge currents from the node nd11 and the node nd13 into a ground voltage terminal VSS. The driver 113 may drive the reference voltage signal VR outputted from a node nd14 in response to voltage signals of the nodes nd12 and nd13 and may supply a constant current IW to the node nd14. The temperature dependent element 12 may be realized using a saturated NMOS transistor N13 that functions as a diode. A gate terminal and a drain terminal of the saturated NMOS transistor N13 may be connected to the node nd14, and a source terminal of the saturated NMOS transistor N13 may be connected to the ground voltage terminal VSS. The saturated NMOS transistor N13 may have a temperature characteristic whereby a resistance value of the saturated NMOS transistor N13 is reduced as a temperature of the semiconductor device, level detection circuit, reference voltage generator 1, temperature dependent element 12, or saturated NMOS transistor N13 rises. Thus, a level of the reference voltage signal VR generated from the reference voltage generator 1 may be lowered as a temperature rises.

Referring to FIG. 3, the level signal generator 2 may include resistors R21 and R22 and a temperature compensation element 21. The resistor R21 may be coupled between a supply terminal of the target voltage signal TV and a node nd 21 through which the level signal LEV is outputted. The resistor R22 may be coupled between the node nd21 and a node nd22. The temperature compensation element 21 may be realized using a saturated NMOS transistor N21 that functions as a diode. A gate terminal and a drain terminal of the saturated NMOS transistor N21 may be connected to the node nd22, and a source terminal of the saturated NMOS transistor N21 may be connected to the ground voltage terminal VSS. The saturated NMOS transistor N21 may have a temperature characteristic that a resistance value of the saturated NMOS transistor N21 is reduced as a temperature of the semiconductor device, level detection circuit, level signal generator 2, temperature compensation element 21, or saturated NMOS transistor N21 rises. The level signal LEV may be generated to have a voltage level of the node nd21 which is divided by a resistance ratio of the resistor R21, the resistor R22 and the temperature compensation element 21. A level of the level signal LEV may be lowered due to the temperature characteristic of the temperature compensation element 21 as a temperature of the saturated NMOS transistor N21 rises. In the present embodiments, the temperature compensation element 21 and the temperature dependent element 12 (as shown in FIG. 2) may be designed to have the same temperature characteristics. Thus, the saturated NMOS transistor N13 and the saturated NMOS transistor N21 may be designed having the same temperature characteristics, and may be formed using the same process. The saturated NMOS transistor N13 and the saturated NMOS transistor N21 may be designed to have the same size as well.

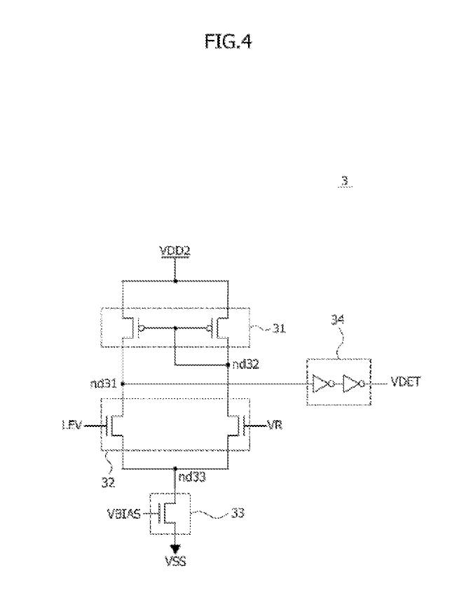

Referring to FIG. 4, the comparator 3 may include a current mirror unit 31, a signal input unit 32, an activation unit 33 and a buffer unit 34. The current mirror unit 31 may supply a current from a second power voltage terminal VDD2 to a node nd31 and a node nd32. The first and second power voltages VDD1 (See FIG. 2) and VDD2 may be different from each other or equal to each other. The signal input unit 32 may determine logic levels of the nodes nd31 and nd32 in response to levels of the level signal LEV and the reference voltage signal VR. The activation unit 33 may discharge a current flowing through a node nd33 into the ground voltage terminal VSS in response to a bias voltage signal VBIAS to activate an operation of the comparator 3. The signal input unit 32 and the activation unit 33 may be connected to each other through the node nd33. The buffer unit 34 may buffer a voltage signal of the node nd31 to output the buffered voltage signal as the detection voltage signal VDET. That is, the comparator 3 may compare a level of the level signal LEV with a level of the reference voltage signal VR to generate the detection voltage signal VDET. The detection voltage signal VDET may be generated to have a logic “low” level when a level of the level signal LEV is higher than a level of the reference voltage signal VR and may be generated to have a logic “high” level when a level of the level signal LEV is lower than a level of the reference voltage signal VR.

As described above, the level detection circuit (see FIG. 1) may detect a level of the target voltage signal TV to generate the detection voltage signal VDET. The detection voltage signal VDET may be generated to have a logic “high” level when the target voltage signal TV does not reach a desired level, that is, when a voltage level of the level signal LEV obtained by dividing a voltage level of the target voltage signal TV is lower than a voltage level of the reference voltage signal VR. In contrast, the detection voltage signal VDET may be generated to have a logic “low” level when the target voltage signal TV exceeds the desired level, that is, when a voltage level of the level signal LEV obtained by dividing a voltage level of the target voltage signal TV is higher than a voltage level of the reference voltage signal VR.

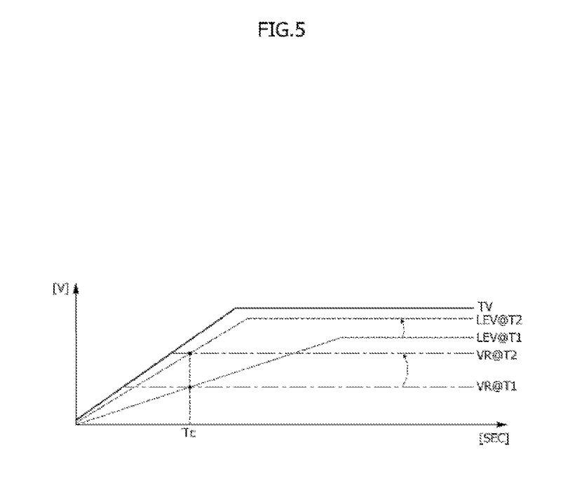

The level detection circuit according to the above embodiments may generate the level signal LEV using the temperature compensation element 21 (see FIG. 3) having the same temperature characteristics as the temperature dependent element 12 (see FIG. 2) included in the reference voltage generator 1 that generates the reference voltage signal VR. Thus, both the levels of the level signal LEV and the reference voltage signal VR may simultaneously rise or fall according to a temperature variation. For example, both of the levels of the level signal LEV and the reference voltage signal VR may be lowered as a temperature of the semiconductor device, level detection circuit, reference voltage generator 1, temperature dependent element 12, saturated NMOS transistor N13, level signal generator 2, temperature compensation element 21, or saturated NMOS transistor N21 rises. In FIG. 5, the abscissa (i.e., x-axis representing seconds [sec]) represents time and the ordinate (i.e., y-axis representing voltage levels of various signals [V]) represents a voltage level of various signals. Referring to FIG. 5, when a temperature of the semiconductor device, level detection circuit, reference voltage generator 1, temperature dependent element 12, saturated NMOS transistor N13, level signal generator 2, temperature compensation element 21, or saturated NMOS transistor N21 varies from a high temperature T1 to a low temperature T2, a level of the reference voltage signal VR may rise (i.e., from VR@T1 or VR at T1 to VR@T2 or VR at T2 as indicated by the arrow) and a level of the level signal LEV generated by dividing a voltage level of the target voltage signal TV may also rise (i.e., from LEV@T1 or LEV at T1 to LEV@T2 or LEV at T2 as indicated by the arrow). A transition moment Tc that the detection voltage signal VDET is changed from a logic “high” level into a logic “low” level by a level change of the target voltage signal TV and the level signal LEV may be substantially the same regardless of temperature variation in the semiconductor device, level detection circuit, reference voltage generator 1, temperature dependent element 12, saturated NMOS transistor N13, level signal generator 2, temperature compensation element 21, or saturated NMOS transistor N21. That is, a level transition moment of the detection voltage signal VDET may be identical regardless of temperature variation in the semiconductor device, level detection circuit, reference voltage generator 1, temperature dependent element 12, saturated NMOS transistor N13, level signal generator 2, temperature compensation element 21, or saturated NMOS transistor N21. Thus, the level detection circuit may stably detect a moment that the target voltage signal TV reaches a desired level or preset level, thereby successfully controlling an internal operation of a semiconductor device.

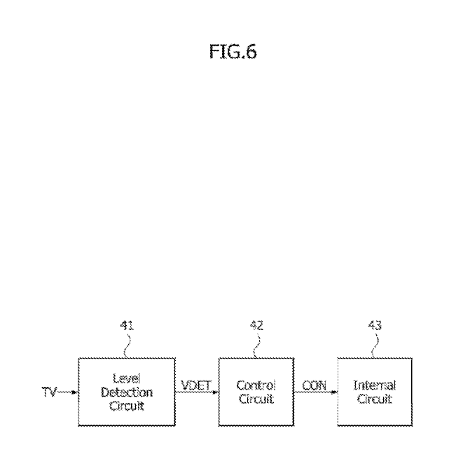

Referring to FIG. 6, a semiconductor device according to an embodiment of the present invention may include a level detection circuit 41, a control circuit 42 and an internal circuit 43. The level detection circuit 41 may detect a level of a target voltage signal TV to generate a detection voltage signal VDET. The level detection circuit 41 may have substantially the same configuration as the level detection circuit described with reference to FIGS. 1 to 5. Thus, a detailed description of the level detection circuit 41 will be omitted hereinafter. The control circuit 42 may generate a control signal CON for controlling an operation of the internal circuit 43 at a level transition moment of the detection voltage signal VDET (i.e., when the detection voltage signal VDET transitions from a high level to a low level or a low level to a high level, and for example, when the target voltage signal TV exceeds a desired level or preset level, or the level signal LEV changes from a high level to a low level or low level to a high level). The internal circuit 43 may be realized to execute diverse operations according to various embodiments. For example, the internal circuit 43 may be realized to execute an initialization operation of an initialization circuit or to execute an operation for driving an internal voltage signal of an internal voltage generation circuit.

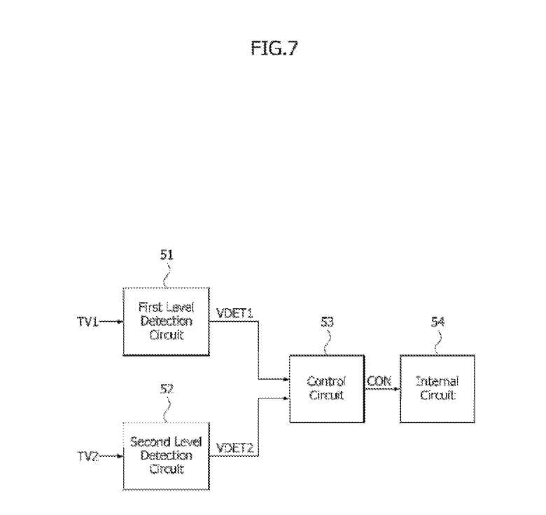

Referring to FIG. 7, a semiconductor device according to an embodiment of the present invention may include a first level detection circuit 51, a second level detection circuit 52, a control circuit 53 and an internal circuit 54. The first level detection circuit 51 may detect a level of a first target voltage signal TV1 to generate a first detection voltage signal VDET1. The second level detection circuit 52 may detect a level of a second target voltage signal TV2 to generate a second detection voltage signal VDET2. Each of the first and second level detection circuits 51 and 52 may have substantially the same configuration as the level detection circuit described with reference to FIGS. 1 to 5. Thus, a detailed description of the first and second level detection circuits 51 and 52 will be omitted hereinafter. The control circuit 53 may generate a control signal CON for controlling an operation of the internal circuit 54 in response to the first and second detection voltage signals VDET1 and VDET2. The control circuit 53 may be realized to execute diverse operations according to various embodiments. For example, the control circuit 53 may be realized to generate the control signal CON enabled when both the levels of the first and second detection voltage signals VDET1 and VDET2 are changed, that is, when both the levels of the first and second detection voltage signals VDET1 and VDET2 are changed from a high level to a low level, a low level to a high level. For example, target voltage signals TV1 or TV2 exceed a desired level or preset level, or the level signals LEV1 or LEV2 change from a high level to a low level or low level to a high level. Alternatively, the control circuit 53 may be realized to generate the control signal CON enabled when the level of the first or second detection voltage signal VDET1 or VDET2 is changed, that is, when the level of the first or second detection voltage signal VDET1 or VDET2 is changed from a high level to a low level, a low level to a high level. For example, target voltage signals TV1 or TV2 exceed a desired level or preset level, or the level signals LEV1 or LEV2 change from a high level to a low level or low level to a high level.

As described above, according to the embodiments, a level change of a reference voltage signal due to a temperature variation may be offset using a temperature compensation element. As a result, a voltage level of a target voltage signal may be stably detected regardless of temperature variation.

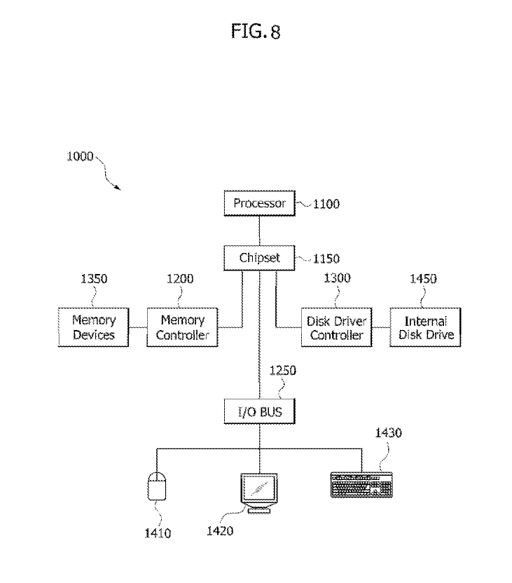

The level detection circuits and semiconductor devices including the same as discussed above with reference to FIGS. 1-7 are particularly useful in the design of memory devices, processors, and computer systems. For example, referring to FIG. 8, a block diagram of a system employing a memory controller in accordance with embodiments of the invention is illustrated and generally designated by a reference numeral 1000. The system 1000 may include one or more processors or central processing units (“CPUs”) 1100. The CPU 1100 may be used individually or in combination with other CPUs. While the CPU 1100 will be referred to primarily in the singular, it will be understood by those skilled in the art that a system with any number of physical or logical CPUs may be implemented.

A chipset 1150 may be operably coupled to the CPU 1100. The chipset 1150 is a communication pathway for signals between the CPU/Processor 1100 and other components of the system 1000, which may include a memory controller 1200, an input/output (“I/O”) bus 1250, and a disk drive controller 1300. Depending on the configuration of the system, any one of a number of different signals may be transmitted through the chipset 1150, and those skilled in the art will appreciate that the routing of the signals throughout the system 1000 can be readily adjusted without changing the underlying nature of the system.

As stated above, the memory controller 1200 may be operably coupled to the chipset 1150. The memory controller 1200 may include at least one semiconductor device or level detection circuit which includes a level signal generator suitable for including a temperature compensation element and suitable for generating a level signal from a target voltage signal, a level of the level signal varying according to a temperature characteristic of the temperature compensation element. Thus, the memory controller 1200 can receive a request provided from the CPU 1100, through the chipset 1150. In alternate embodiments, the memory controller 1200 may be integrated into the chipset 1150. The memory controller 1200 may be operably coupled to one or more memory devices 1350. In an embodiment, the memory devices 1350 may be corresponded to the level detection circuits discussed above with regards to FIGS. 1-7. The memory devices 1350 may also include a plurality of word lines and a plurality of bit lines for defining a plurality of memory cell. The memory devices 1350 may be any one of a number of industry standard memory types, including but not limited to, single inline memory modules (“SIMMs”) and dual inline memory modules (“DIMMs”). Further, the memory devices 1350 may facilitate the safe removal of the external data storage devices by storing both instructions and data.

The chipset 1150 may also be coupled to the I/O bus 1250. The I/O bus 1250 may serve as a communication pathway for signals from the chipset 1150 to I/O devices 1410, 1420 and 1430. The I/O devices 1410, 1420 and 1430 may include a mouse 1410, a video display 1420, or a keyboard 1430. The I/O bus 1250 may employ any one of a number of communications protocols to communicate with the I/O devices 1410, 1420, and 1430. Further, the I/O bus 1250 may be integrated into the chipset 1150.

The disk drive controller 1450 may also be operably coupled to the chipset 1150. The disk drive controller 1450 may serve as the communication pathway between the chipset 1150 and one or more internal disk drives 1450. The internal disk drive 1450 may facilitate disconnection of the external data storage devices by storing both instructions and data. The disk drive controller 1300 and the internal disk drives 1450 may communicate with each other or with the chipset 1150 using virtually any type of communication protocol, including all of those mentioned above with regard to the I/O bus 1250.

It is important to note that the system 1000 described above in relation to FIG. 8 is merely one example of a system employing a memory controller or memory device having function for stably detecting a voltage level of a target voltage signal regardless of temperature variations. In alternate embodiments, such as cellular phones or digital cameras, the components may differ from the embodiment shown in FIG. 8.

What is claimed is:

1. A level detection circuit comprising:
a reference voltage generator suitable for including a temperature dependent element and suitable for generating a reference voltage signal whose level varies according to a temperature characteristic of the temperature dependent element;
a level signal generator suitable for including a temperature compensation element and suitable for generating a level signal from a target voltage signal, a level of the level signal varying according to a temperature characteristic of the temperature compensation element; and
a comparator suitable for comparing a level of the level signal with a level of the reference voltage signal to generate a detection voltage signal.

2. The level detection circuit of claim 1, wherein the temperature compensation element has substantially the same temperature characteristic as the temperature dependent element.

3. The level detection circuit of claim 1,
wherein the reference voltage generator further includes a constant current source suitable for supplying a constant current regardless of temperature variation to an output node through which the reference voltage signal is outputted; and
wherein the temperature dependent element is electrically connected to the output node.

4. The level detection circuit of claim 3, wherein if a temperature rises in the level detection circuit, a resistance value of the temperature dependent element is reduced to lower a level of the reference voltage signal.

5. The level detection circuit of claim 4, wherein the temperature dependent element is realized using a saturated NMOS transistor.

6. The level detection circuit of claim 3, wherein the constant current source includes:
a current supplier suitable for supplying a current to a first node and a second node;
a resistor coupled between the second node and a third node;
a current discharger suitable for discharging currents flowing through the first and third nodes; and
a driver suitable for driving the reference voltage signal in response to signals of the second and third nodes.

7. The level detection circuit of claim 1, wherein if a temperature rises in the level detection circuit, a resistance value of the temperature compensation element is reduced to lower a level of the level signal.

8. The level detection circuit of claim 7, wherein the level signal generator further includes a first resistor and a second resistor for dividing a level of the target voltage signal, whereby the first resistor is coupled in series with the second resistor and the first resistor is suitable for receiving the target voltage signal.

9. The level detection circuit of claim 7, wherein the temperature compensation element is realized using a saturated NMOS transistor.

10. The level detection circuit of claim 1, wherein the level signal generator further includes:
a first resistor coupled between a supply terminal of the target voltage signal and a first node through which the level signal is outputted; and
a second resistor coupled between the first node and a second node,
wherein the temperature compensation element is coupled between the second node and a ground voltage terminal.

11. A semiconductor device comprising:
a level detection circuit suitable for comparing a level of a level signal generated from a target voltage signal with a level of a reference voltage signal to generate a detection voltage signal; and
a control circuit suitable for generating a control signal for controlling an internal circuit in response to the detection voltage signal,
wherein a level of the reference voltage signal varies according to a temperature characteristic of a temperature dependent element,
wherein a level of the level signal varies according to a temperature characteristic of a temperature compensation element.

12. The semiconductor device of claim 11, wherein the temperature characteristic of the temperature dependent element is set to be substantially identical to the temperature characteristic of the temperature compensation element.

13. The semiconductor device of claim 11, wherein the level detection circuit includes:
a reference voltage generator suitable for generating a reference voltage signal whose level varies according to the temperature characteristic of the temperature dependent element;
a level signal generator suitable for generating the level signal by dividing a voltage level of the target voltage signal; and
a comparator suitable for comparing a level of the level signal with a level of the reference voltage signal to generate the detection voltage signal.

14. The semiconductor device of claim 12, wherein the reference voltage generator includes:
a constant current source suitable for supplying a constant current regardless of temperature variation to an output node through which the reference voltage signal is outputted; and
the temperature dependent element electrically connected to the output node.

15. The semiconductor device of claim 14, wherein if a temperature rises in the semiconductor device, a resistance value of the temperature dependent element is reduced to lower a level of the reference voltage signal.

16. The semiconductor device of claim 15, wherein the temperature dependent element is realized using a saturated NMOS transistor.

17. The semiconductor device of claim 14, wherein the constant current source includes:
a current supplier suitable for supplying a current to a first node and a second node;
a resistor coupled between the second node and a third node;
a current discharger suitable for discharging currents flowing through the first and third nodes; and
a driver suitable for driving the reference voltage signal in response to signals of the second and third nodes.

18. The semiconductor device of claim 13, wherein if a temperature rises in the semiconductor device, a resistance value of the temperature compensation element is reduced to lower a level of the level signal.

19. The semiconductor device of claim 18, wherein the level signal generator further includes a first resistor and a second resistor for dividing a level of the target voltage signal, whereby the first resistor is coupled in series with the second resistor and the first resistor is suitable for receiving the target voltage signal.

20. The semiconductor device of claim 18, wherein the control circuit generates the control signal for controlling the internal circuit when the detection voltage signal transitions from a first level to a second level whereby the second level is lower than the first level.

21. The semiconductor device of claim 18, wherein the control circuit generates the control signal for controlling the internal circuit when the target voltage signal exceeds a preset level.

22. A semiconductor device comprising:
a first level detection circuit suitable for comparing a level of a first level signal generated from a first target voltage signal with a level of a first reference voltage signal to generate a first detection voltage signal;
a second level detection circuit suitable for comparing a level of a second level signal generated from a second target voltage signal with a level of a second reference voltage signal to generate a second detection voltage signal; and
a control circuit suitable for generating a control signal for controlling an internal circuit in response to the first and second detection voltage signals,
wherein a level of the first reference voltage signal varies according to a temperature characteristic of a first temperature dependent element,
wherein a level of the first level signal varies according to a temperature characteristic of a first temperature compensation element.

23. The semiconductor device of claim 22, wherein the temperature characteristic of the first temperature dependent element is set to be substantially identical to the temperature characteristic of the first temperature compensation element.

24. The semiconductor device of claim 22, wherein the first level detection circuit includes:
a reference voltage generator suitable for generating the first reference voltage signal whose level varies according to the temperature characteristic of the first temperature dependent element;
a level signal generator suitable for generating the first level signal by dividing a voltage level of the first target voltage signal; and
a comparator suitable for comparing a level of the first level signal with a level of the first reference voltage signal to generate the first detection voltage signal.

25. The semiconductor device of claim 24,
wherein a level of the second reference voltage signal varies according to a temperature characteristic of a second temperature dependent element,
wherein a level of the second level signal varies according to a temperature characteristic of a second temperature compensation element, and
wherein the temperature characteristic of the second temperature dependent element is set to be identical to the temperature characteristic of the second temperature compensation element.

26. The semiconductor device of claim 25, wherein the second level detection circuit includes:
a reference voltage generator suitable for generating the second reference voltage signal whose level varies according to the temperature characteristic of the second temperature dependent element;
a level signal generator suitable for generating the second level signal by dividing a voltage level of the second target voltage signal; and
a comparator suitable for comparing a level of the second level signal with a level of the second reference voltage signal to generate the second detection voltage signal.

27. The semiconductor device of claim 25, wherein control circuit generates the control signal for controlling the internal circuit when either the first target voltage signal or the second target voltage signal exceeds a preset level.
